(19) United States
(12) Patent Application Publication
(10) Pub. No.: US 2010/0304674 A1
(43) Pub. Date: Dec. 2, 2010

(54) SYSTEM AND METHOD FOR CONNECTING BLUETOOTH DEVICES

(75) Inventors: Sang Don KIM, Hwaseong-si (KR); Jin Ho JANG, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/791,231

(22) Filed: Jun. 1, 2010

(30) Foreign Application Priority Data
Jun. 1, 2009 (KR) 10-2009-0047952

(51) Int. Cl. H04B 7/00

(52) U.S. Cl. 455/41.2

(57) ABSTRACT

A system and method for connecting Bluetooth devices are provided. The system includes a first device comprising a Bluetooth module, a relay terminal for transmitting information regarding the first device selected by a touch signal together with a Bluetooth connection request, and a second device for receiving the Bluetooth connection request and device information from the relay terminal, for analyzing the received Bluetooth connection request and the device information, and for transmitting a Bluetooth connection response accepting the request to the first device. The information includes an address of the first device and a name of the first device.

### PRIORITY

This application claims the benefit under 35 U.S.C. §119(a) of a Korean patent application filed on Jun. 1, 2009 in the Korean Intellectual Property Office and assigned Serial No. 10-2009-0047952, the entire disclosure of which is hereby incorporated by reference.

### BACKGROUND OF THE INVENTION

1. Field of the Invention

The present invention relates to Bluetooth communication. More particularly, the present invention relates to a system and method for connecting Bluetooth devices through a relay terminal having a list of various Bluetooth devices.

2. Description of the Related Art

Advances in wireless communication technology have enabled development of low-cost and low-power wireless devices and links. Bluetooth is an example of a short-range communication scheme that enables low-cost and low-power voice and data communication between devices. Bluetooth operates in an Industrial, Scientific and Medical (ISM) band of 2.4 GHz. Bluetooth may cover a radius of 10m and support a data rate of 1 Mbps for voice and data transmission.

A Bluetooth device may support multiple profiles related to specific applications and transfer files and audio data in various formats. To transmit and receive data through Bluetooth communication, a first Bluetooth device may have to search for a second Bluetooth device and establish a connection to the second Bluetooth device in advance.

Normally, for data transfer or streaming, a server Bluetooth device searches for connectable client Bluetooth devices and transmits a Bluetooth connection request to a selected one of the found client Bluetooth devices. By following this process, the user may be inconvenienced by having to repeat this inquiry and connection procedure.

Therefore, a need exists for a system and method for readily establishing a connection between Bluetooth devices.

### SUMMARY OF THE INVENTION

An aspect of the present invention is to address the above-mentioned problems and/or disadvantages and to provide at least the advantages described below. Accordingly, an aspect of the present invention is to provide a system and method for connecting Bluetooth devices for Bluetooth communication through a relay terminal having a list of various Bluetooth devices.

Another aspect of the present invention is to provide a system and method for easily connecting pre-registered Bluetooth devices through a relay terminal for data communication without explicit inquiry.

In accordance with an aspect of the present invention, a system for connecting Bluetooth devices is provided. The system includes a first device comprising a Bluetooth module, a relay terminal for transmitting information regarding the first device selected by a touch signal together with a Bluetooth connection request, and a second device for receiving the Bluetooth connection request and device information from the relay terminal, for analyzing the received Bluetooth connection request and the device information, and for transmitting a Bluetooth connection response accepting the request to the first device.

In accordance with another aspect of the present invention, a system for connecting Bluetooth devices is provided. The system includes a touch screen for displaying a list of connectable Bluetooth devices, and a control unit for selecting, in a Bluetooth connection mode, a first device and a second device among the devices in the Bluetooth device list according to the touch signal, and for transmitting information to the second device, the information comprising an address of the first device and a name of the first device.

In accordance with another aspect of the present invention, a method for connecting Bluetooth devices is provided. The method includes entering into, by a relay terminal, a Bluetooth connection mode to connect a first device with a second device through Bluetooth communication, displaying a list of multiple Bluetooth devices usable as one of the first device and the second device on a screen in the Bluetooth connection mode, selecting devices in the Bluetooth device list as the first device and the second device according to a touch signal, and transmitting information regarding the first device together with a Bluetooth connection request to the second device.

In an exemplary embodiment of the present invention, a user may readily establish a Bluetooth connection between Bluetooth devices using a relay terminal. Client device information may be transmitted to a server device through a touch input to the relay terminal, enabling convenient generation of a Bluetooth connection request.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a system for connecting Bluetooth devices according to an exemplary embodiment of the present invention;

FIG. 2 is a block diagram of a relay terminal connecting Bluetooth devices according to an exemplary embodiment of the present invention;

FIG. 3 is a sequence diagram depicting a method for connecting Bluetooth devices according to an exemplary embodiment of the present invention;

FIG. 4 is a flowchart illustrating a procedure for a relay terminal for establishing a Bluetooth connection according to an exemplary embodiment of the present invention;

FIGS. 5A to 5D illustrate screen representations related to the procedure of FIG. 4 according to exemplary embodiments of the present invention;

FIG. 6 is a flowchart illustrating a procedure for adding a new Bluetooth device according to an exemplary embodiment of the present invention; and

FIGS. 7A to 7F illustrate screen representations related to the procedure of FIG. 6 according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

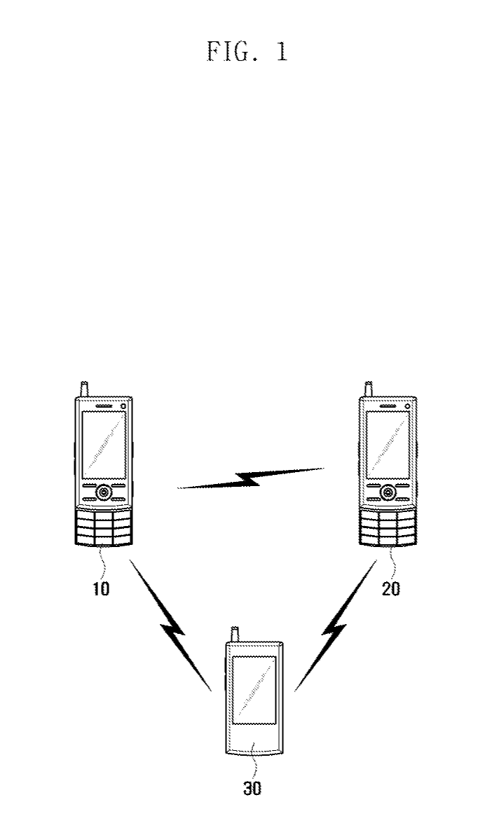

FIG. 1 illustrates a system for connecting Bluetooth devices according to an exemplary embodiment of the present invention.

Referring to FIG. 1, the system includes a first device 10, a second device 20, and a relay terminal 30.

Each of the first device 10 and the second device 20 is a Bluetooth device capable of communicating with the relay terminal 30, and may be a mobile terminal, a headset, a handsfree terminal, a printer, a facsimile, and the like. Each of the first device 10 and the second device 20 may use short-range wireless communication based on Bluetooth, Infrared Data Association (IrDA), Zigbee, and the like, and may employ other wireless communication modules capable of establishing a short-range communication connection for signal exchange.

The Bluetooth protocol operates in a license-free Industrial, Scientific and Medical (ISM) band of 2.4 GHz. A lower guard band of 2 MHz wide and an upper guard band of 3.5 MHz wide are provided respectively below and above the ISM band to prevent interference with other devices. Bluetooth uses frequency hopping at a rate of 1600 hops per second.

The first device 10 and the second device 20 may function as a server or client in Bluetooth communication. More specifically, in a case where the second device 20 functions as a server, when a Bluetooth connection request and information regarding the first device 10 serving as a client are received from the relay terminal 30, the second device 20 analyzes the received request and information and may transmit a Bluetooth connection response to the first device 10. In a case where the first device 10 functions as a server, when a Bluetooth connection request and information regarding the second device 20 serving as a client are received from the relay terminal 30, the first device 10 analyzes the received request and information and may transmit a Bluetooth connection response to the second device 20.

When data communication is performed using a profile for file transfer provided in a Bluetooth specification, the first device 10 may function as a client and the second device 20 may function as a server. Here, the file for profile transfer may be an Object Push Profile (OPP), a File Transfer Profile (FTP), a Basic Printing Profile (BPP), a Basic Imaging Profile (BIP), and the like. When data communication is performed using a profile for audio transfer provided in the Bluetooth specification, the first device 10 may function as an audio gateway and the second device 20 may be a headset or a handsfree terminal. When data communication is performed using the profile for audio transfer provided in the Bluetooth specification, the first device 10 may function as a streaming source and the second device 20 may be a stereo headset or a handsfree terminal. Here, the profile for audio transfer may be a HeadSet Profile (HSP), a HandsFree Profile (HFP), an Advanced Audio Distribution Profile (A2DP)+Audio/Video Remote Control Profile (AVRCP), and the like.

The relay terminal 30 is a Bluetooth device capable of performing Bluetooth communication with the first device 10 and the second device 20. The relay terminal 30 may use short-range wireless communication based on Bluetooth, IrDA, Zigbee, and the like, and may employ other wireless communication modules capable of establishing a short-range communication connection for signal exchange. More particularly, the relay terminal 30 may maintain information regarding Bluetooth devices previously connected, and may establish a Bluetooth connection to the individual Bluetooth devices using the maintained information. Here, the relay terminal 30 may transmit a Bluetooth connection request and information regarding the first device 10 (not information on the relay terminal 30) to the second device 20. In return, the second device 20 may regard the Bluetooth connection request as a connection request coming from the first device 10 (not from the relay terminal 30), and transmit a Bluetooth connection response to the first device 10. In addition, the relay terminal 30 may search for a new Bluetooth device within the Bluetooth range.

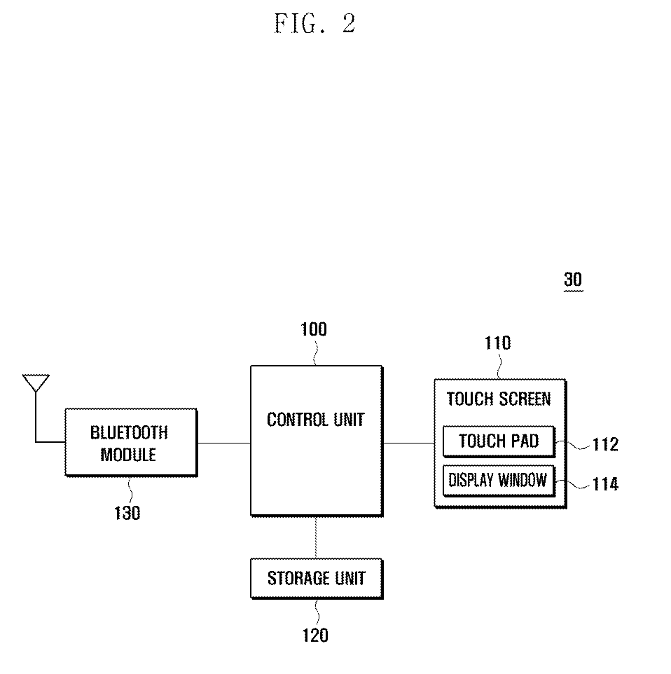

FIG. 2 is a block diagram of a relay terminal connecting Bluetooth devices according to an exemplary embodiment of the present invention.

Referring to FIG. 2, the relay terminal 30 may include a touch screen 110, a storage unit 120, a Bluetooth module 130, and a control unit 100.

The touch screen 110 may include a touch pad 112 and a display window 114. The touch pad 112 may include a touch sensor (not illustrated), which includes a touch detector (not illustrated) and a signal converter (not illustrated). The touch detector may detect a change in a physical quantity such as resistance or electrostatic capacity caused by touch. The signal converter generates a touch signal corresponding to the detected change in the physical quantity. In this case, the touch screen 110 may function as an input means. More particularly, when a touch signal corresponding to a drag and drop is generated by a user, the touch pad 112 may transmit coordinates of a start point and an end point of a touch to the control unit 100. The display window 114 displays various information regarding a state and operation of the relay terminal 30. The display window 114 may be implemented using Liquid Crystal Display (LCD) technology, and may include an LCD controller and LCD elements. More particularly, the display window 114 may display information regarding Bluetooth devices previously connected, and may display a list of newly found Bluetooth devices classified as a client or a server in response to a user request. The display window 114 may also display a list of Bluetooth devices, including the Bluetooth devices previously connected and the Bluetooth devices newly found, classified as a client or a server.

The storage unit 120 may store application programs related to exemplary embodiments of the present invention. The storage unit 120 may include a program area and a data area. More particularly, the program area may store an Operating System (OS) for booting the relay terminal 30, a program for identifying a Bluetooth device corresponding to coordinates of a touched location, and a program for transmitting information regarding a first device 10 selected by a user touch to a second device 20.

The data area may store data generated by the use of the relay terminal 30, and user data related to various optional functions. More particularly, the data area may store information regarding Bluetooth devices previously connected. The data area may store a list of connectable Bluetooth devices that are in a vicinity of the relay terminal 30 and selected by the user.

The Bluetooth module 130 may transmit and receive voice and data signals through a wireless interface to and from another Bluetooth device. The Bluetooth module 130 may forward the received signals to the control unit 100. The Bluetooth module 130 may receive information regarding a Bluetooth device within a range from the Bluetooth module of the Bluetooth device. More particularly, in response to a device search request from the user, the Bluetooth module 130 may broadcast an inquiry message while hopping between preset radio frequency channels, transmit a name request, and receive response messages from responding Bluetooth devices. Under the control of the control unit 100, the Bluetooth module 130 may transmit information regarding a first device 10 stored in the storage unit 120 to a second device 20.

The control unit 100 controls the overall operation of the relay terminal 30 and controls signal exchange between internal blocks thereof. More particularly, when a Bluetooth mode is activated, the control unit 100 may enter into a Bluetooth connection mode. In the Bluetooth connection mode, information regarding a Bluetooth device that is selected as a client from a list of Bluetooth devices on the screen may be transmitted to a server. Here, the list of Bluetooth devices may include a stored list of Bluetooth devices previously connected and classified as a client or a server. The list of Bluetooth devices may include a Bluetooth device selected from a list of newly found Bluetooth devices that are located nearby. In response to a Bluetooth search request from the user, the control unit 100 may discover all connectable Bluetooth devices within the Bluetooth range. The control unit 100 may control the Bluetooth module 130 to receive device information including an address and name of each found Bluetooth device.

The control unit 100 may add a selected one of the found Bluetooth devices as a first device 10 into a first device list. The control unit 100 may add a selected one of the found Bluetooth devices as a second device 20 into a second device list.

In response to a user request, the control unit 100 may display a list of Bluetooth devices, including the Bluetooth devices previously connected and the Bluetooth devices newly found, classified as a client or a server, on a single screen.

The control unit 100 may detect a touch signal from the user for selecting one of the Bluetooth devices that are listed on the screen and classified as a client or a server. More specifically, the control unit 100 may detect a drag-and-drop touch signal on the screen displaying Bluetooth devices classified as a client or a server. Upon detection of a drag-and-drop touch signal, the control unit 100 may obtain coordinates of the start point and end point of the touch, and transmit information regarding a Bluetooth device indicated by the start point coordinates to a Bluetooth device indicated by the end point coordinates. That is, the control unit 100 may transfer client device information to a server device as part of a Bluetooth connection request.

After selection of a client device, the control unit 100 may detect generation of a touch signal for transferring the client device information to a server device. Here, the control unit 100 may transmit both a Bluetooth connection request and client device information to the server device.

An exemplary method for connecting Bluetooth devices using a relay terminal is described in more detail below.

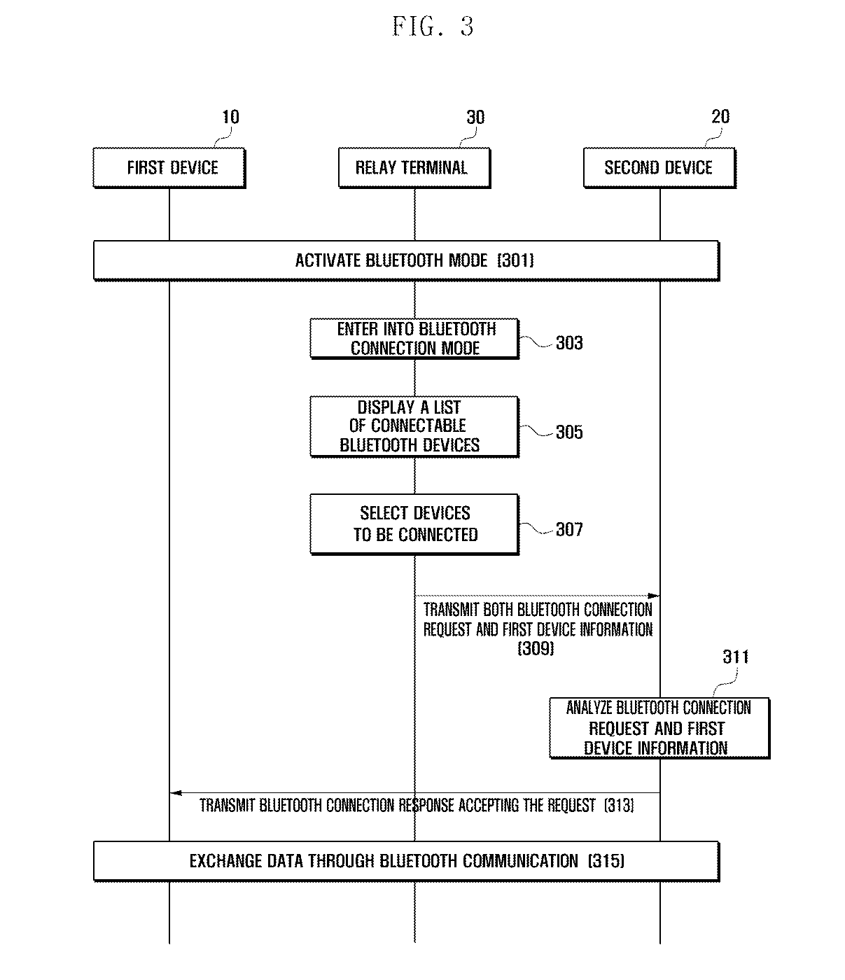

FIG. 3 is a sequence diagram depicting a method for connecting Bluetooth devices according to an exemplary embodiment of the present invention.

Referring to FIG. 3, in step 301, to connect a relay terminal 30 with a first device 10 and a second device 20 for Bluetooth communication, each of the first device 10, the second device 20 and the relay terminal 30 activates a Bluetooth mode. After activation of the Bluetooth mode, in step 303, the relay terminal 30 enters into a Bluetooth connection mode. Here, the relay terminal 30 may detect a touch signal from a user requesting the Bluetooth connection mode.

In the Bluetooth connection mode, the relay terminal 30 displays a list of connectable Bluetooth devices on a screen in step 305. Here, the list of connectable Bluetooth devices may include Bluetooth devices previously connected and Bluetooth devices that are newly found within the Bluetooth range.

In step 307, the relay terminal 30 selects the first device 10 and the second device 20 for connection according to a drag-and-drop touch signal from the user. Here, the first device 10 may be indicated by the start point coordinates of the touch, and the second device 20 may be indicated by the end point coordinates. In step 309, the relay terminal 30 transmits both a Bluetooth connection request and information on the first device 10 indicated by the start point coordinates to the second device 20 indicated by the end point coordinates. That is, the relay terminal 30 transmits both a Bluetooth connection request and information regarding the first device 10 (not on the relay terminal 30) to the second device 20 so that the second device 20 may recognize the Bluetooth connection request as a request coming from the first device 10.

In step 311, upon reception of the Bluetooth connection request, the second device 20 analyzes the received request and associated information. Hence, the second device 20 may identify an address of the first device 10 and a name of the first device 10.

In step 313, the second device 20 transmits a Bluetooth connection response accepting the request to the first device 10. Thereafter, in step 315, the first device 10 and the second device 20 exchange data through Bluetooth communication.

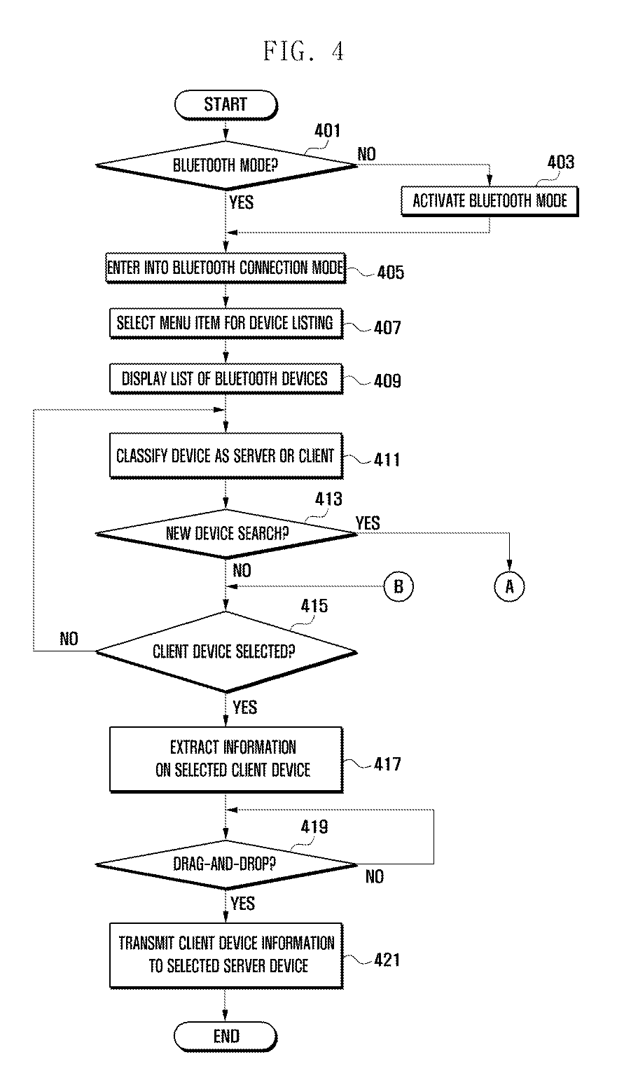

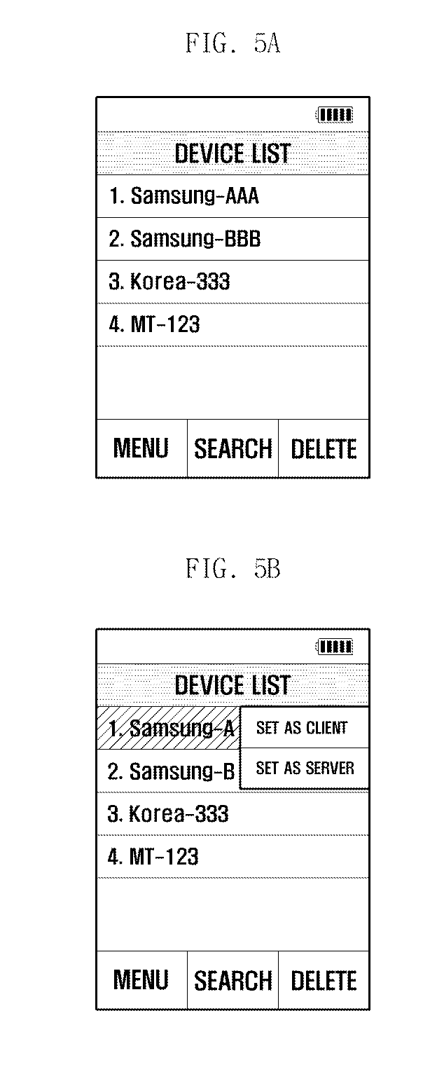

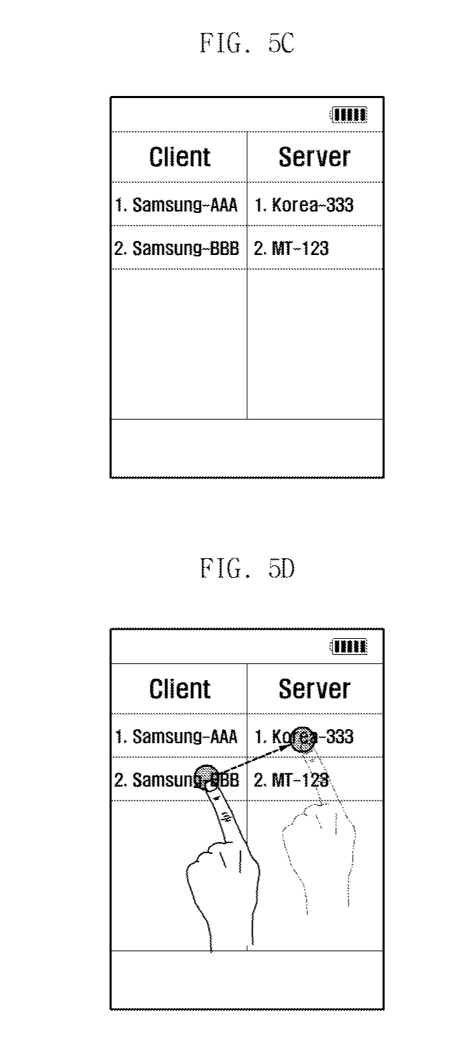

FIG. 4 is a flowchart illustrating a procedure for a relay terminal for establishing a Bluetooth connection according to an exemplary embodiment of the present invention. FIGS. 5A to 5D illustrate screen representations related to the procedure of FIG. 4 according to exemplary embodiments of the present invention.

Referring to FIG. 4, in step 401, the control unit 100 of the relay terminal 30 verifies activation of a Bluetooth mode. In step 403, when the Bluetooth mode is not activated, the control unit 100 activates the Bluetooth mode. In step 405, when the Bluetooth mode is activated, the control unit 100 enters into a Bluetooth connection mode.

In the Bluetooth connection mode, the control unit 100 controls to display menus related to the Bluetooth connection mode, and selects an item for device listing according to a user touch signal in step 407.

In step 409, upon selection of the device listing item, the control unit 100 controls to display a list of Bluetooth devices that have been previously connected on the screen. Here, the storage unit 120 may store the list of Bluetooth devices that have been previously connected and are classified as a client or a server. For example, as illustrated in FIG. 5A, the control unit 100 may control to display a list of Bluetooth devices that have been previously connected (e.g., “Samsung-AAA”, “Samsung-BBB”, “Korea-333” and “MT-123”) on the screen. The user may remove an undesired device from the device list.

In step 411, the control unit 100 classifies a Bluetooth device in the device list as a server or a client according to a touch signal from the user. For example, as illustrated in FIG. 5B, when a device “Samsung-AAA” is selected, the control unit 100 may control to display a pop-up containing “set as client” and “set as server”. The control unit 100 may add the device “Samsung-AAA” into a client list or a server list according to a user selection. The remaining devices may also be classified as a client or a server. After classification, the control unit 100 may control to display the client list and the server list on the screen as illustrated in FIG. 5C.

Thereafter, in step 413, the control unit 100 verifies generation of a signal for a new device search from the user. When a signal for the new device search is generated, the control unit 100 performs a device search procedure, which is described in more detail below with reference to FIG. 6.

In step 415, when a signal for the new device search is not generated, the control unit 100 verifies generation of a touch signal for client selection. When a touch signal for client selection is not generated, the control unit 100 returns to step 411. In step 415, when a touch signal for client selection is generated, the control unit 100 extracts information regarding the selected client device in step 417.

After extraction of the client device information in step 417, the control unit 100 verifies whether the touch signal for client selection is a drag-and-drop signal in step 419. When the touch signal for client selection is a drag-and-drop signal, the control unit 100 transmits the client device information to a selected server device in step 421. Here, the control unit 100 may transmit the client device information together with a Bluetooth connection request to the server device. For example, as illustrated in FIG. 5D, the control unit 100 may transmit the address and name of a client device “Samsung-BBB” in the client list selected by a drag-and-drop to a server device in the server list selected by the drag-and-drop. After transmitting the client device information, the control unit 100 may control to display a notice “requesting Bluetooth connection” on the screen.

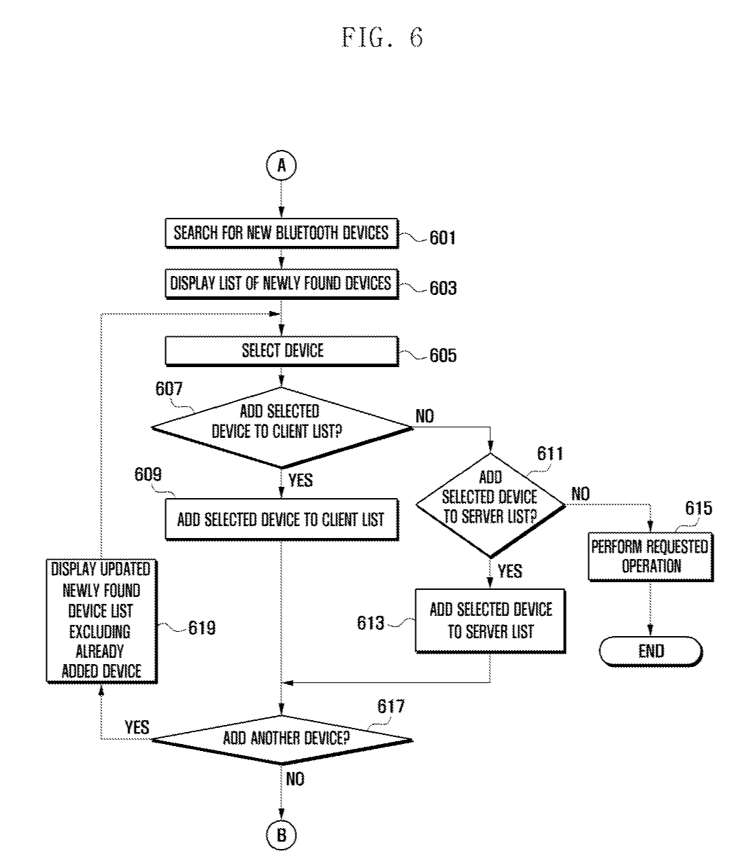

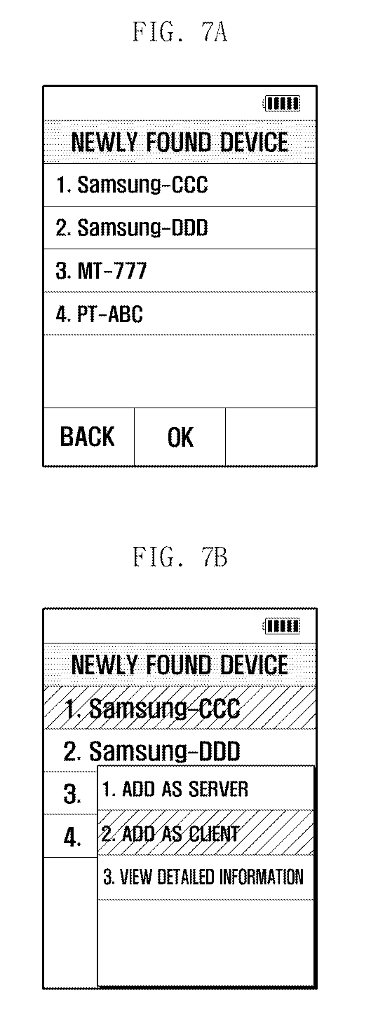

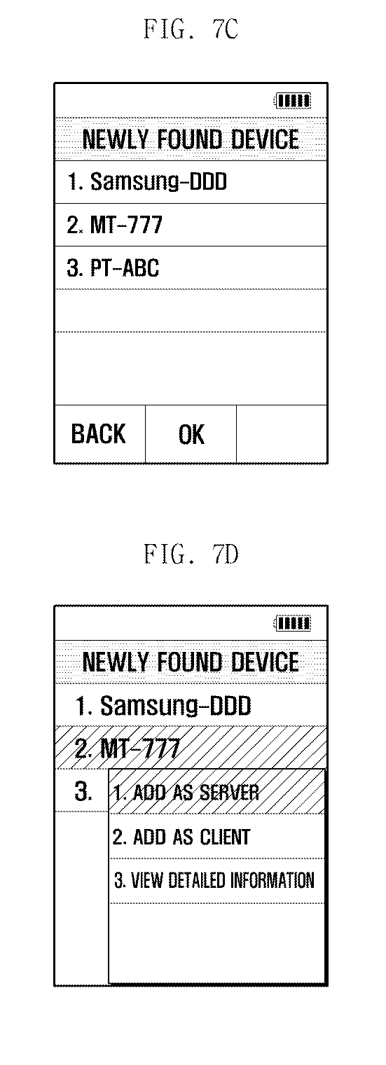

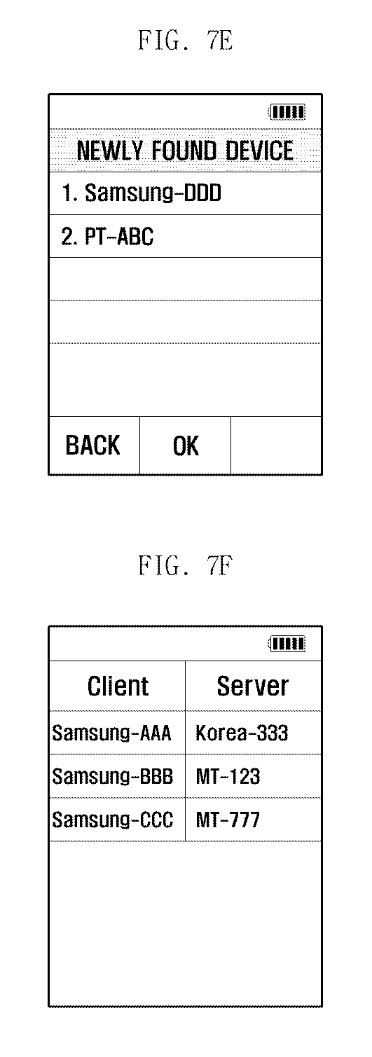

FIG. 6 is a flowchart illustrating a procedure for adding a new Bluetooth device according to an exemplary embodiment of the present invention. FIGS. 7A to 7F illustrate screen representations related to the procedure of FIG. 6 according to exemplary embodiments of the present invention.

Referring to FIG. 6, in response to a signal for new device search from a user, a control unit 100 of a relay terminal 30 searches for new Bluetooth devices within a Bluetooth range in step 601. Here, the control unit 100 controls the Bluetooth module 130 to obtain information regarding all connectable Bluetooth devices within the Bluetooth range. In step 603, the control unit 100 controls to display a list of newly found devices on the screen. For example, as illustrated in FIG. 7A, a list of newly found devices, such as “Samsung-CCC”, “Samsung-DDD”, “MT-777” and “PT-ABC” may be displayed on the screen.

In step 605, the control unit 100 selects a device in the newly found device list according to a touch signal. In step 607, the control unit 100 requests the user to determine whether to add the selected device to the client list. When the user generates a signal for adding the selected device to the client list in step 607, the control unit 100 adds the selected device to the client list in step 609. Here, the control unit 100 may store information regarding the selected device in the storage unit 120. For example, as illustrated in FIG. 7B, when a device “Samsung-CCC” in the newly found device list is selected by the user, the control unit 100 requests the user to determine whether to add the selected device to the client list. When the user determines to add the selected device to the client list, the control unit 100 adds the device “Samsung-CCC” to the client list. As illustrated in FIG. 7C, the control unit 100 controls to redisplay the newly found device list including “Samsung-DDD”, “MT-777” and “PT-ABC” except for the device “Samsung-CCC” having been added to the client list. The control unit 100 may store information regarding the device “Samsung-CCC” classified as a client in the storage unit 120.

When the user generates a signal for not adding the selected device to the client list, the control unit 100 requests the user to decide whether to add the selected device to the server list in step 611. When the user generates a signal for adding the selected device to the server list in step 611, the control unit 100 adds the selected device into the server list in step 613. Here, the control unit 100 may store information regarding the added device in the storage unit 120. For example, as illustrated in FIG. 7D, when a device “MT-777” in an updated newly found device list is selected by the user, the control unit 100 requests the user to decide whether to add the selected device to the server list. When the user decides to add the selected device to the server list, the control unit 100 adds the selected device “MT-777” to the server list. The control unit 100 may store information regarding the added device “MT-777” in the storage unit 120. As illustrated in FIG. 7E, the control unit 100 controls to redisplay the newly found device list including “Samsung-DDD” and “PT-ABC”, except for the device “MT-777” having been added to the server list. In addition, as illustrated in FIG. 7F, the control unit 100 may control to display a list of Bluetooth devices, including the Bluetooth devices previously connected and the Bluetooth devices newly added, classified as a client or a server.

When the user generates a signal for not adding the selected device into the client list or the server list in step 611, the control unit 100 performs an operation indicated by the signal in step 615. Here, the control unit 100 may control to display detailed information regarding the selected device including the address and name on the screen.

In step 617, the control unit 100 verifies generation of a signal for adding another device in the newly found device list to the client list or the server list. When a signal for adding another device is generated in step 617, the control unit 100 controls to display the updated newly found device list excluding the device already added to the client list or the server list in step 619, and returns to step 605. When a signal for adding another device is not generated in step 617, the control unit 100 returns to the process of FIG. 4.

In an exemplary implementation, the function of the relay terminal of the present invention may be performed by a regular Bluetooth device (not by a separate independent device). That is, the first device or the second device may perform the function of the relay terminal to establish a Bluetooth connection. A Bluetooth device supporting the relay terminal function may store information regarding other Bluetooth devices previously connected, and transmit information regarding a first Bluetooth device together with a Bluetooth command to a second Bluetooth device. The Bluetooth device supporting the relay terminal function may include a touch screen as an input means.

The above-described methods according to exemplary embodiments of the present invention may be implemented in hardware, or as software or computer code that may be stored in a recording medium, such as a CD Read-Only Memory (ROM), a Random-Access Memory (RAM), a floppy disk, a hard disk, a magneto-optical disk or downloaded over a network, so that the methods described herein may be executed by such software using a general purpose computer or a special processor, or in programmable or dedicated hardware, such as an Application-Specific Integrated Circuit (ASIC) or a Field Programmable Gate Array (FPGA). As would be understood in the art, the general purpose computer, the special processor or the programmable hardware include memory components, e.g., RAM, ROM, Flash, and the like, that may store or receive software or computer code, When the software or computer code is accessed and executed by the general purpose computer, the special processor or the programmable hardware, the software or computer code implement the processing methods described herein. In addition, it would be recognized that when the general purpose computer accesses code for implementing the processing methods herein, execution of the code transforms the general purpose computer into a special purpose computer for executing the processing methods herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A system for connecting Bluetooth devices, the system comprising:
a first device comprising a Bluetooth module;
a relay terminal for transmitting information regarding the first device selected by a touch signal together with a Bluetooth connection request; and
a second device for receiving the Bluetooth connection request and device information from the relay terminal, for analyzing the received Bluetooth connection request and the device information, and for transmitting a Bluetooth connection response accepting the request to the first device.

2. The system of claim 1, wherein the relay terminal comprises:
a touch screen for displaying a list of connectable Bluetooth devices; and
a control unit for selecting, in a Bluetooth connection mode, the first device and the second device among the devices in the Bluetooth device list according to the touch signal, and for transmitting information regarding the first device to the second device.

3. The system of claim 2, wherein the control unit displays a list of Bluetooth devices previously connected and classified as one of the first device and the second device in the Bluetooth connection mode.

4. The system of claim 2, wherein the control unit searches for Bluetooth devices according to a request, determines whether to add a selected one of found Bluetooth devices to at least one of a first device list and a second device list, and displays the device list comprising a newly added found Bluetooth device.

5. The system of claim 4, wherein the control unit extracts, in response to a touch on the first device list, information regarding a Bluetooth device of the first device list indicated by a start point of the touch, and extracts information on a Bluetooth device of the second device list indicated by an end point of the touch.

6. The system of claim 5, wherein the touch corresponds to a drag and drop.

7. The system of claim 2, wherein the control unit transmits information regarding the first device selected, the information comprising an address of the first device and a name of the first device, to the second device as part of the Bluetooth connection request.

8. The system of claim 2, wherein the relay terminal further comprises a storage unit for storing information regarding devices of the Bluetooth device list.

9. A method for connecting Bluetooth devices, the method comprising:
entering into, by a relay terminal, a Bluetooth connection mode to connect a first device with a second device through Bluetooth communication;
displaying a list of multiple Bluetooth devices usable as one of the first device and the second device on a screen in the Bluetooth connection mode;
selecting devices in the Bluetooth device list as the first device and the second device according to a touch signal; and
transmitting information regarding the first device together with a Bluetooth connection request to the second device.

10. The method of claim 9, wherein the displaying of the list of multiple Bluetooth devices comprises displaying a list of Bluetooth devices previously connected and classified as one of the first device and the second device in the Bluetooth connection mode.

11. The method of claim 9, wherein the displaying of the list of multiple Bluetooth devices comprises:
searching for Bluetooth devices according to a request;
determining whether to add a selected one of found Bluetooth devices to at least one of a first device list and a second device list; and
adding the selected Bluetooth device to one of the first device list and the second device list according to the determination.

12. The method of claim 11, wherein the selecting of the devices in the Bluetooth device list comprises:
determining a touch on a device of the first device list;
extracting information regarding a Bluetooth device of the first device list indicated by a start point of the touch; and
extracting information regarding a Bluetooth device of the second device list indicated by an end point of the touch.

13. The method of claim 12, wherein the touch corresponds to a drag and drop.

14. The method of claim 9, wherein the transmitting of the information regarding the first device comprises transmitting information regarding the first device selected, the information comprising an address of the first device and a name of the first device, to the second device as part of the Bluetooth connection request.

15. The method of claim 9, further comprising storing information regarding devices of the Bluetooth device list.
